(19) United States
(12) Patent Application Publication
(10) Pub. No.: US 2019/0342618 A1
(43) Pub. Date: Nov. 7, 2019

(54) VIDEO-CONTENT-DISTRIBUTION PLATFORM INTEGRATED WITH ADVERTISEMENT AND REWARD COLLECTION MECHANISMS

(71) Applicant: SOCIAL MEDIA BROADCASTER, LLC, Los Angeles, CA (US)

(72) Inventor: Mykhailo DUDKO, Los Angeles, CA (US)

(21) Appl. No.: 16/474,308

(22) PCT Filed: Jan. 2, 2018
(86) PCT No.: PCT/US2018/012122

§ 371 Date: Jun. 27, 2019

Related U.S. Application Data
(60) Provisional application No. 62/539,653, filed on Aug. 1, 2017.
(60) Provisional application No. 62/476,773, filed on Mar. 25, 2017.
(60) Provisional application No. 62/440,428, filed on Dec. 30, 2016.

(51) Int. Cl. H04N 21/4784; H04N 21/482; H04N 21/81; H04N 21/431; H04N 21/472; H04N 21/2668

(52) U.S. Cl. CPC H04N 21/4784; H04N 21/4826; H04N 21/2668; H04N 21/4316; H04N 21/472; H04N 21/812

(57) ABSTRACT

The disclosed embodiments provide a subscription-based video-content-distribution platform for providing a wide range of video contents from a wide range of content providers (including both social-media-influencer (SMI) video producers and non-SMI video producers) to the subscribers of the video content distribution platform and also promote a wide range of products and services associated with participating advertisers to the subscribers through the video contents distributed on the video-content-distribution platform. The disclosed content-distribution platform allows advertisers to reach a wide range of audiences, including both the subscribers of the video-content-distribution platform and followers of participating SMIs via their multiple social media accounts; and also allows the advertisers to allocate an amount of products and/or services as reward distribution among the subscribers in return for receiving media-buying-free advertisements of the products and services on the video-content-distribution platform.

### BACKGROUND

### Field

This patent document relates to systems, devices, and processes for providing a video content distribution platform integrated with product and service advertisement and reward distribution/collection mechanisms.

### Related Art

Rapid growth in online advertisement spending has resulted in massive use of commercial breaks (similar to those used in TV programs) both before and during the consumption (i.e., playback) of video content distributed through social media and online video-sharing/hosting websites, such as YouTube®, Dailymotion®, Hulu®, vimeo®, etc. Similar to advertisement on TV, advertisers have been spending heavily on online media buying. In return for the paid media, advertisers are able to expose their products and services to the audience of the online content (i.e., prospective consumers). However, in the conventional online advertisement platforms, even though the audience gets to see what they can buy from the advertisers, they are often forced to watch the commercials and pay for it with their time. This can lead to negative impressions toward the advertised products and services among some audience.

Hence, there is a need for a more efficient, user-friendly and cost-effective online advertising platform.

### SUMMARY

Some embodiments of the disclosed video content distribution platform (hereinafter also referred to as “the technology” and/or the “the platform”) are designed to allow advertisers to reach a wide target audience through collaborative production and distribution of video content with independent social media influencer (or “SMI” and/or “SMIs” hereinafter) free of media-buying expenses in return for the ability to reward active target audience with advertised products or services. The disclosed platform allows its subscribers/users to explore available video content by name or genre of the video content these subscribers/users are interested in, by the talents who host the video programs (e.g., SMIs), and also by the available reward(s) subscribers/users can get from a particular advertiser(s). For example, if a subscriber/user is interested to travel to Paris, this subscriber/user can search for the video content that features relevant sponsors (e.g., travel operators, hotels, restaurants, airfare, etc.), watch the relevant shows, and subsequently collect/claim reward points if such rewards exist. In some embodiments, a certain period of time after a relevant product or service is purposely displayed on the screen and/or while SMIs are interacting with a product or service, a pop-up window appears to suggest subscribers/users to claim the reward points. In some embodiments, upon collecting a required amount of reward points, subscribers/users receive the reward from the advertiser(s). As such, advertisers using the disclosed platform can promote their products and services directly to their prospective customers and build loyalty relationship, while not paying for media-buying.

Disclosed techniques, systems, and devices include a subscription-based video content distribution platform which is designed to distribute a wide range of video content (including video content produced for social media-based and non-social-media-based video content) from a wide range of content providers including the SMIs, film, TV and video producers to the subscribers of the video content distribution platform, while integrating in the narrative of storytelling of distributed video content and promoting a wide range of products and services associated with a wide range of participating advertisers to the subscribers through the video contents distributed on the video content distribution platform. The disclosed video content distribution platform allows advertisers to reach a wide range of target audiences, including both users/subscribers of the video content distribution platform and followers of participating SMIs via their multiple social media accounts.

The disclosed video content distribution platform also provides a unique advertising model for the advertisers based on using “tie-in” product placement promotional advertisement and reward-based distribution of products and services in return for media-buying-free advertisements. In some embodiments, the disclosed video content distribution platform provides a free media buying model. In other words, the disclosed video content distribution platform does not charge a fee for the advertisers advertising their products and services on the video content distribution platform. Instead, an alternative Ads buying model is used where advertisers are required to allocate promoted products and services as reward distribution among the subscribers of the video content distribution platform. Hence, the disclosed video content distribution platform can redirect up to 100% of Ad revenues to the users/subscribers as an added benefit of subscription and incentive to keep making payments to the platform and watching the videos on the platform.

The disclosed video content distribution platform is designed to provide separate sets of interests and incentives to each of the parties using the video content distribution platform, i.e., content providers who produce the video contents for the video content distribution platform, such as the SMIs; the subscribers/users who subscribe to the video content distribution platform to watch videos produced by the content providers and distributed on the content distribution platform; and advertisers who promote their products and services on the video content distribution platform through the videos produced by the content providers and watched by the subscribers.

In one aspect of this patent disclosure, a process for providing reward points associated with products and services of a group of advertisers to a subscriber of a video content distribution platform is disclosed. This process includes performing the steps of: displaying a list of available rewards offered by the group of advertisers on a screen of a subscriber's device; receiving a first selection from the subscriber of a desired reward from the list of available rewards; displaying, on the screen of the subscriber's device, a list of relevant videos from a content library of the video content distribution platform based on the first selection, wherein the relevant videos include embedded advertisements associated with the desired reward; receiving a second selection from the subscriber of a desired video from the list of relevant videos; and playing, on the screen of the subscriber's device, the selected video based on the second selection. Hence, the disclosed process allows the subscriber to claim reward points associated with the desired reward while watching the selected video.

In some embodiments, the process creates the list of relevant videos by: creating a set of entertainment videos in collaboration with a group of social media influencers (SMIs); embedding advertisements of products and/or services of the group of advertisers into the set of entertainment videos; and associating the embedded advertisements in the set of entertainment videos with the list of available rewards to create the list of relevant videos.

In some embodiments, the process embeds the advertisements of the products and/or services of the group of advertisers into the set of entertainment videos by integrating the products and/or services with the narratives of the set of entertainment videos.

In some embodiments, the process integrates the products and/or services with the narratives of the set of entertainment videos by creating products and/or services placement advertisements in the set of entertainment videos to tied in the products and/or services with the storytelling within the set of entertainment video.

In some embodiments, the process further includes performing the steps of: while playing the selected video, determining that an embedded advertisement within the selected video is being shown on the screen; displaying a small window on the screen while the selected video is being played; receiving an input from the subscriber caused by the subscriber interacting with the small window; and providing a predetermined amount of reward points associated with the desired reward of the subscriber to the subscriber. Hence, the disclosed process allows the subscriber to collect the reward points when the selected video is being played without pausing the video, which ensures an uninterrupted viewing experience to the subscriber.

In some embodiments, the small window disappears from the screen after a limited time period, and the subscriber is only able to collect the reward points if the subscriber interacts with the small window before the small window disappears.

In some embodiments, the small window includes a countdown timer, and the subscriber needs to claim the reward points by interacting with the small window before the countdown timer reaches zero.

In some embodiments, the process further includes performing the steps of: determining that the subscriber has claimed a sufficient amount of reward points toward the desire reward; and displaying on a side of the screen options to allow the subscriber to redeem the desire reward right now or at a later time.

In some embodiments, the process only allows the subscriber to claim the reward points associated with the desired reward during a first streaming session of the selected video.

In some embodiments, the group of advertisers allocates an amount of products and/or services as reward distribution among a group of subscribers of the video content distribution platform in return for receiving media-buying-free advertisements of the products and services on the video content distribution platform.

In another aspect of this patent disclosure, a process for administrating reward points associated with a product or a service to a viewer watching a video program containing advertisements on a screen is disclosed. This process includes performing the steps of: determining that an advertisement associated with an advertiser is being shown to the viewer watching the video program; while the advertisement is being shown or immediately after the advertisement has been shown, displaying a pop-up window at an off-center location of the screen; and awaiting the viewer to interact with the pop-up window within a limited time period. If a viewer interaction with the pop-up window is detected within the limited time period, the process then provides a predetermined amount of reward points associated with the advertisement and the advertiser to the viewer. However, if no viewer interaction with the pop-up window is detected within the limited time period, the process prevents the predetermined amount of reward points associated with the advertisement and the advertiser from being provided to the viewer. Moreover, the pop-up window disappears from the screen immediately after the limited time period, thereby preventing further viewer interaction with the pop-up window.

In some embodiments, the video program includes one of a social media live show being broadcasted or an archived social media show being played-back from a video content library.

In some embodiments, the advertisement includes one of: a product placement advertisement, a running banner advertisement, and a standard linear video advertisement.

In some embodiments, the pop-up window has a size significantly smaller than the size of the screen so that the pop-up window does not block the screen.

In some embodiments, the pop-up window does not interrupt either the video program or the advertisement being playing on the screen.

In some embodiments, the viewer interaction with the pop-up window includes one of: a press on the pop-up window, a touch on the pop-up window, a swipe on the pop-up window, a click on the pop-up window, and another form of interaction with the pop-up window.

In some embodiments, the viewer does not receive the predetermined amount of reward points associated with the advertisement and the advertiser if the viewer fails to interact with the pop-up window during the limited time period.

In some embodiments, the reward points associated with the advertisement and the advertiser are provided to the viewer only if the viewer has actually watched the advertisement, thereby motivating the viewer to watch the advertisement.

In some embodiments, the limited time period is relatively short so that the viewer needs to take prompt action after the pop-up window appears on the screen.

In some embodiments, the pop-up window includes a countdown timer indicating the remaining time before the pop-up window disappears from the screen.

In yet another aspect of this patent disclosure, another process for providing reward points associated with products and services of a group of advertisers to a subscriber of a video content distribution platform is disclosed. This process includes performing the steps of: providing the subscriber with a reward search interface; receiving a reward search term from the subscriber for a desired reward through the reward search interface; determining if the desired reward is among a set of available rewards provided by the group of advertisers. If so, the process further performs the steps of: displaying a list of relevant videos from a video content library based on the desired reward; receiving a selection from the subscriber of a desired video from the list of relevant videos; and playing, on the screen of the subscriber's device, the selected video based on the selection, whereby allowing the subscriber to claim reward points associated with the desired reward while watching the selected video.

### BRIEF DESCRIPTION OF THE FIGURES

FIG. 1 shows a block diagram illustrating an exemplary system for providing reward points to a viewer watching social-media-based programs containing advertisements on a screen in accordance with some embodiments described herein.

FIG. 2 presents a flowchart illustrating a process of providing reward points associated with a product or service from an advertiser to a viewer watching a video content using the proposed SMB application in accordance with some embodiments described herein.

FIG. 3 shows a block diagram illustrating an exemplary operation of a disclosed video content distribution platform through which the subscribers, the advertisers, and the content providers interact with one another in accordance with some embodiments described herein.

FIG. 4 shows a screen grab illustrating an exemplary user interface of the disclosed video content distribution platform for browsing, searching, and selecting video content based on genres and titles of the shows in accordance with some embodiments described herein.

FIG. 5 shows a screen grab illustrating an exemplary user interface of the disclosed video content distribution platform for browsing, searching, and selecting video content based on the host SMIs of the shows in accordance with some embodiments described herein.

FIG. 6 shows a screen grab illustrating an exemplary user interface of the disclosed video content distribution platform for browsing, searching, and selecting video content based on the available rewards and benefits in accordance with some embodiments described herein.

FIG. 7 shows a screen grab illustrating an exemplary user interface of the disclosed video content distribution platform for displaying available “magic hour” shows and associated high monetary value prizes in accordance with some embodiments described herein.

FIG. 8 shows a screen grab illustrating an exemplary user profile page of a subscriber to the disclosed video content distribution platform in accordance with some embodiments described herein.

FIG. 10 presents a flowchart illustrating a process of providing reward points associated with products and services from a group of advertisers to a subscriber of the video content distribution platform in accordance with some embodiments described herein.

FIG. 11 conceptually illustrates a computer system with which some embodiments of the subject technology are implemented.

In the figures, like reference numerals refer to the same figure elements

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

In this patent disclosure, various examples of a subscription-based video content distribution platform are disclosed, wherein the disclosed video content distribution platform provides a wide range of video contents (including both social-media-based videos and non-social-media-based videos) from a wide range of content providers (including both social media influencer (SMIs) video producers and non-SMI video producers, such as film/TV/video producers) to the subscribers of the video content distribution platform. In some embodiments, through the video contents distributed on the disclosed video content distribution platform (also referred to as “the platform” or “the disclosed platform” hereinafter), the disclosed video content distribution platform integrates the original video contents such as storytelling with promotions of a wide range of products and services associated with a wide range of participating advertisers, so that the subscribers can be exposed to the advertisers' products and services through the video contents distributed on the video content distribution platform. As a result, the disclosed video content distribution platform allows the advertisers to reach a wide range of target audiences, including both users/subscribers of the video content distribution platform and followers of participating SMIs via their multiple social media accounts.

In various embodiments, the disclosed video content distribution platform also provides a unique advertising model for the advertisers to increase the incentives of the advertisers to participate in the disclosed video content distribution platform. More specifically, the disclosed advertising model is based on using “tie-in” product placement promotional advertisement and reward-based distribution of products and services in return for media-buying-free advertisements. Hence, in some embodiments, the disclosed video content distribution platform provides a free media buying model. In other words, the disclosed video content distribution platform does not charge a fee for the advertisers to advertise their products and services on the video content distribution platform. Instead, an alternative Ads buying model is used where advertisers are required to allocate promoted products and services as reward distribution among the subscribers of the video content distribution platform. Hence, the disclosed video content distribution platform can redirect up to 100% of traditional Ad revenues to the users/subscribers of the video content distribution platform as an added benefit of subscription and incentive to keep making payments to the platform and watching the videos on the platform.

The disclosed video content distribution platform is designed to provide separate sets of interests and incentives to each of the parties using the video content distribution platform, i.e., (1) the content providers who produce the video contents for the video content distribution platform, such as the SMIs; (2) the subscribers/users who subscribe to the video content distribution platform to watch videos produced by the content providers and distributed on the content distribution platform; and (3) the advertisers who promote their products and services on the video content distribution platform through the videos produced by the content providers and watched by the subscribers.

In some embodiments, video contents distributed on the disclosed video content distribution platform can include both live-streaming and on-demand-play of social-media-based TV shows. Related patent application 62/440,428, the content of which is incorporated by reference herein, provides exemplary systems and techniques for producing and broadcasting a live social-media-based TV show, such as a live social media reality show. For example, the related patent application discloses a social media broadcaster system configured to create a live social-media-based TV show based on multiple live video streams produced by multiple social media influencers who serve as hosts for the live show. The disclosed social media broadcaster system in the related application provides a unique production pipeline that allows for a real-time collaborative production of a “TV-like” reality show among multiple SMIs and live broadcast/distribution of the produced social-media-based TV shows based on a disclosed production format. The live broadcast of the produced social-media-based TV shows can be simultaneously distributed through multiple social media influencers' existing social media accounts associated with multiple social media platforms to a large number of followers of the SMIs.

In some embodiments, the disclosed social media broadcaster system in the related application is configured to add sales related metadata into a complete episode of a live show, which can include announcement(s) of live events, ticket sales and hyperlinks to third party ticket sales operators. Hence, the disclosed social media broadcaster system in the related application allows the user to buy tickets for live events (e.g., through hyperlink to ticket operators) while watching the produced live shows.

In some embodiments, after the live broadcast/distribution, live social-media-based TV shows produced by the disclosed social media broadcaster system can be archived in a video content library, where the video content library can be either coupled to or within the disclosed video content distribution platform. Hence, to watch the archived shows again, an audience needs to access the video content library through the video content distribution platform. In some embodiments, the video content library contains both free-to-watch content (or “free content” hereinafter) and paid-to-watch content (or “premium content” hereinafter).

In some embodiments, for subscribers of the disclosed video content distribution platform, the archived social-media-based TV shows can be viewed on-demand at a later time through the disclosed video content distribution platform. The disclosed video content distribution platform can include features to incentivize/motivate an audience to watch archived shows in the content library. These features can be implemented in a social media broadcaster (SMB) application. In some embodiments, using the disclosed SMB application, a subscriber of the disclosed video content distribution platform can access the archived shows both through some dedicated channels of distribution and through existing personal social media accounts of the SMIs who host the social-media-based TV shows.

### Reward-Point-Based Video Content Distribution Platform

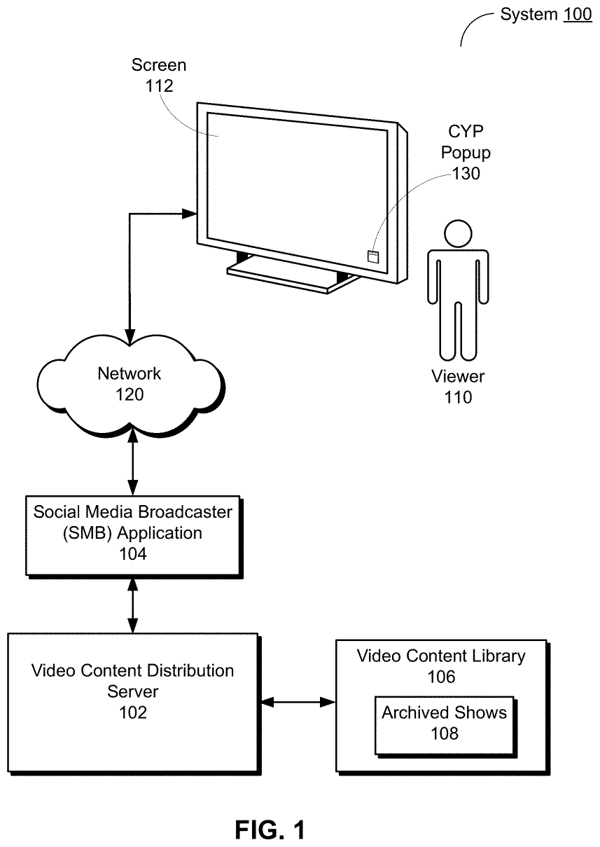

FIG. 1 shows a block diagram illustrating an exemplary system 100 for providing reward points to a viewer 110 watching social-media-based programs containing advertisements on a screen 112 in accordance with some embodiments described herein. As can been seen in FIG. 1, system 100 includes a video content distribution server 102, a social media broadcaster (SMB) application 104, and a video content library 106, which are coupled to one another. In some embodiments, SMB application 104 can include programs/functions for providing both live social media shows and archived social media shows to viewer 110. In some embodiments, SMB application 104 also includes programs/functions to provide incentives to viewer 110 to watch archived shows 108 through video content library 106. As can be seen in FIG. 1, archived shows 108 are stored in video content library 106 coupled to video content distribution server 102.

SMB application 104 can be a web application, a mobile application, a native application, and/or another type of client-server application that can be accessed by video content distribution server 102 over a network 120. In some embodiments, video content distribution server 102 can be a single computing device such as a computer server. In other embodiments, video content distribution server 102 can represent more than one computing device working together to perform the actions of a server computer (e.g., cloud computing). The one or more computing devices within video content distribution server 102 can include one or more processors for executing SMB application 104 in one or more forms. Video content distribution server 102 can be communicably coupled to screen 112 of viewer 110 via network 120. In some embodiments, video content distribution server 102 can host SMB application 104, and as such SMB application 104 is stored within video content distribution server 102. In some embodiments, video content distribution server 102 can host video content library 106.

In some embodiments, SMB application 104 is designed to incentivize an audience to watch archived shows 108 through video content library 106, which contains both free-to-watch content (or “free content”) and paid-to-watch content (or “premium content”). In some embodiments, audience can subscribe to SMB application 104 with one of the two options: a paid subscription and a free subscription. For each subscription type, the audience can receive a set of incentives which can be promoted to the audience by a host SMI during broadcasting of a live show or playback of an archived show.

In some embodiments, viewer 110 initially watches a live show on a social media account of a host SMI whom viewer 110 follows. During the live show, the host SMI can promote SMB application 104 used to access the archived shows 108 in order to make viewer 110 to watch the other SMI shows by subscribing to SMB application 104, wherein SMB application 104 can provide both free content watching and premium content watching options through video content library 106. In some embodiments, the host SMIs are incentivized/motivated to promote SMB application 104 during the live show because SMB application 104 provides the audience the option to join a monthly paid subscription to watch the premium content. In one example, when a follower of a host SMI purchases the prime account of SMB application 104, the host SMI can receive a subscriber reward, e.g., $1 per month per prime account subscriber that the host SMI brings. The host SMI can also receive 100% of Ad revenues from the shows that the host SMI has produced.

In some embodiments, the followers of the multiple host SMIs can receive automatic push notifications whenever a host SMI uploads new content. This allows the produced live content to reach a much wider audience in real-time at a significantly lower cost, in comparison with traditional reality TV shows which are produced and aired by traditional networks.

In some embodiments, using the disclosed SMB application 104 through a paid subscription, viewer 110 receives full access to video content library 106, which can include full access to all archived episodes of the previously broadcasted live shows. In some embodiments, viewer 110 through the paid subscription can watch the archived shows via an Ad free GUI to get the optimal viewing experience. In some embodiments, viewer 110 through the paid subscription can also have access to a smart TV version of SMB application 104, so that viewer 110 can watch the content on a TV screen. In some embodiments, viewer 110 through the paid subscription can also receive “Prime-Your-Time” (PYT) rewards/bonus points when watching shows through SMB application 104. These PYT rewards/bonus points are described in more detail below. As mentioned above, the incentives for a given SMI to promote paid-subscriptions to his/her followers can include both a monthly subscriber reward and the 100% Ad revenues.

Alternatively, using the disclosed SMB application 104 through a free subscription, viewer 110 can watch selected content in video content library 106 for free, wherein the free content can include selected episodes of the previously broadcasted live shows. Viewer 110 through the free subscription can also receive push notifications on his/her mobile devices from SMB application 104. In some embodiments, viewer 110 through the free subscription can also receive the aforementioned PYT rewards/bonus points when watching shows through SMB application 104. These PYT rewards/bonus points are described below in more detail. In some embodiments, for each viewer/follower of a host SMI with such a free subscription, the host SMI can still receive Ad revenue when the viewer/follower watches the free content through SMB application 104.

Prime-Your-Time (PYT) Rewards/Bonus Points

In some embodiments, SMB application 104 includes a system and process for providing a type of reward points, referred to as “Prime-Your-Time” (PYT) rewards/bonus points or simply “PYT points” to viewer 110 watching video contents through video content library 106. In some embodiments, the proposed PTY rewards/bonus points can be provided to and received by viewer 110 when viewer 110 is watching shows on screen 112 through SMB application 104, regardless whether viewer 110 is under free-subscription or paid-subscription. More specifically, during the playback of an archived show, various advertisements from various participating advertisers can be embedded and/or inserted into the video program. These advertisements can include, but are not limited: a product placement, a running banner, and a standard linear video Ad. The proposed PTY points reward system functions in such a manner that when viewer 110 watches an advertisement, which can be in any of the above-described formats, viewer 110 can get paid for his/her time through the proposed PYT points reward system. In some embodiments, after acquiring a sufficient amount of PYT points with a particular advertiser, the audience can exchange the acquired points for real-life prizes/rewards directly thought SMB application 104.

For example, if viewer 110 who is subscribed to video content library 106 (hence also referred to as “subscribed viewer 110” hereinafter) has acquired a sufficient amount of PYT points with American Airlines by watching plenty of Ads when watching a show or shows that American Airlines sponsor, viewer 110 can receive a free ticket to Hawaii as one of his/her rewards. In some embodiments, subscribed viewer 110 will only be able to receive the disclosed PYT points if viewer 110 watches the shows through SMB application 104. In some embodiments, the disclosed PYT points which have been acquired by subscribed viewer 110 are not exchangeable between sponsors/advertisers. In other words, subscribed viewer 110 acquires PYT points from each sponsor/advertiser separately, meaning that subscribed viewer 110 cannot use one sponsor/advertiser's PYT points for another sponsor/advertiser's product (e.g., Starbucks points cannot be used to get a discount on a Sephora product).

In some embodiments, while both free and paid-subscriptions to SMB application 104 and video content library 106 provide viewer 110 the ability to acquire PYT bonus points, viewer 110 through paid-subscription receives a premium account, and the proposed PTY points reward system is designed to provide significantly more bonus points for each Ad paid-subscription viewer 110 watches compared to a viewer who has only a free subscription.

Claim-Your-Points Pop-Ups

In some embodiments, the disclosed SMB application 104 also includes programs/functions which are designed to incentivize/motivate subscribed viewer 110 to actually watch the embedded Ads while watching shows on screen 112. For example, the disclosed SMB application 104 can include a program/function which is designed such that subscribed viewer 110 can collect the aforementioned PYT rewards/bonus points through SMB application 104 only by actually watching the Ads associated with shows being played on screen 112, thereby incentivizing/motivating subscribed viewer 110 to actually watch the Ads.

In some embodiments, the disclosed SMB application 104 includes a pop-up-window-based program/function (also referred to as “Claim-Your-Points (CYP) pop-up program/function hereinafter) for incentivizing/motivating subscribed viewer 110 to actually watch the Ads. In some embodiments, the proposed CYP pop-up program operates in conjunction with the above-described PYT points reward system. More specifically, the proposed CYP pop-up program is configured to generate a pop-up window (also referred to as a “CYP pop-up” hereinafter) designed to appear in a corner of a display screen, such as on screen 112, either during each advertisement or after each advertisement is shown to viewer 110 while he/she is watching a show through SMB application 104.

In some embodiments, the disclosed CYP pop-up is designed to be sufficiently small so that it does not block the screen. In some embodiments, the disclosed CYP pop-up is designed to be available, i.e., being displayed only for a very short period of time but which is also long enough to allow the viewer sufficient time to interact with the CYP pop-up. For example, the duration which the CYP pop-up is displayed on screen 112 can be between 3-5 seconds. Because the disclosed CYP pop-up is configured to be much smaller in size than the screen size and appears at a corner of the screen for only a very short period of time, the disclosed CYP pop-up neither blocks the screen nor interrupts the show or whatever program is playing on the screen. Moreover, the proposed CYP pop-up program is designed such that viewer 110 has to interact with the CYP pop-up during the display duration of the CYP pop-up in order to collect the PYT Rewards/bonus points associated with the advertisement. As mentioned above, this function can be achieved by the collaboration of the proposed CYP pop-up program and the above-described PYT points reward system. Note that the disclosed CYP pop-up can be configured as an interactive pop-up window.

As an example of using the disclosed CYP pop-up to collect the PYT points in system 100 of FIG. 1, viewer 110 is watching a show hosted by a group of SMIs. During the show, one of the host SMIs picks up a bottle of Coca Cola and starts drinking it, which is designed as a product placement Ad. As soon as the scene with the host SMI drinking the Coca Cola is over, a CYP pop-up 130 appears in the corner of screen 112, while the show continues to run without interruption. However, CYP pop-up 130 will only appear, i.e., be displayed for a very short time period, e.g., 3-5 seconds during which time viewer 110 needs to press/touch/swipe/click or use another form of interaction to interact with CYP pop-up 130 in order to receive the PYT rewards/bonus points associated with the Coca Cola product placement Ad. If viewer 110 fails to press/touch/swipe/click or use another form of interaction to interact with the CYP pop-up 130 during this short time frame, CYP pop-up 130 disappears from screen 112 and viewer 110 cannot claim and does not receive the PYT points associated with that specific Coca Cola product placement Ad.

Note that the although the above example is described in term of a product placement Ad, the disclosed CYP pop-up can also function in conjunction with a standard linear video Ad which can appear before, during, or after a regular show. For example, if a linear video Ad is played as a commercial break during the playback of an archived show episode, a CYP pop-up can appear in a corner of the screen during or after the linear video Ad is shown for a short time period, such as for 3-5 seconds. Again, viewer 110 needs to press/touch/swipe/click or use another form of interaction to interact with the CYP pop-up in order to receive the PYT rewards/bonus points associated with the linear video Ad. If the viewer fails to press/touch/swipe/click or use another form of interaction to interact with the CYP pop-up during this short time period, the CYP pop-up disappears from screen 112 and viewer 110 cannot claim and does not receive the PYT points associated with that specific linear video Ad.

Note that one important feature of the proposed CYP pop-up program is that, because the disclosed CYP pop-up is only available for a very short period of time, such as 3-5 seconds, viewers are unable to cheat the system by simply leaving their viewing devices on for a long period of time, such as a whole day playing the shows and acquiring lots of PYT points without actually watching the shows and embedded Ads. Through this feature, the proposed SMB application 104 ensures to advertisers that viewers actually watch their Ads, instead of just somehow having the Ads played to get the PYT rewards/bonus points without actually watching the Ads. In some embodiments, the disclosed CYP pop-up can also display a countdown timer indicating the remaining time before the CYP pop-up disappears from the screen.

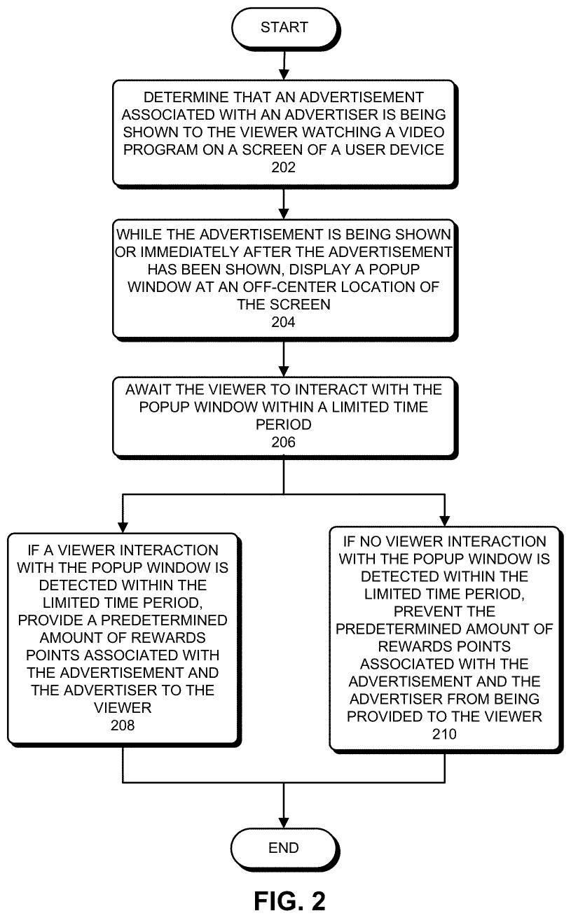

FIG. 2 presents a flowchart illustrating a process of providing reward points associated with a product or service from an advertiser to a viewer watching a video content using the proposed SMB application 104 in accordance with some embodiments described herein. In some embodiments, the process begins by determining that an advertisement associated with an advertiser is being shown to the viewer watching a video program on a screen of the user device, such as screen 112 in FIG. 1 (step 202). Note that the video program can include a social media live show being broadcasted through an SMI's social media channel or an archived social media show played-back from a video content library. Moreover, the advertisement can include one of: a product placement advertisement, a running banner advertisement, and a standard linear video advertisement.

Next, while the advertisement is being shown or immediately after the advertisement has been shown, the process displays a pop-up window at an off-center location of the screen (step 204). In some embodiments, the pop-up window is displayed near a corner of the screen (e.g., similar to that of CYP pop-up 130). In some embodiments, the pop-up window is displayed near one of the edges of the screen. Although the pop-up window does not have been displayed at one of the corners of the screen, it may be preferable from a user-experience standpoint that the pop-up window is displayed off the center of the screen. In some embodiments, the pop-up window has a size significantly smaller than the size of the screen so that the pop-up window does not block the screen.

Moreover, the pop-up window is only displayed for a predetermined and limited time period on the screen before it appears from the screen. In some embodiments, the limited time period is relatively short so that the viewer needs to take prompt action after the pop-up window appears on the screen. However, the limited time period needs to be sufficiently long to allow the viewer an ample of amount time to interact with the pop-up window after the pop-up window appears on the screen. In some embodiments, the limited time period is between 3-5 seconds. In some embodiments, the pop-up window can also display a countdown timer indicating the remaining time before the pop-up window disappears from the screen.

Returning to FIG. 2, after the initial display of the pop-up window, the process then awaits the viewer of the video program to interact with the pop-up window within the limited time period (step 206). Note that due to the small size and short lifespan of the pop-up window, the pop-up window does not interrupt either the video program or the advertisement being shown on the screen.

If a viewer interaction with the pop-up window is detected within the predetermined and limited time period, the process then provides a predetermined amount of rewards points associated with the advertisement and the advertiser to the viewer (step 208). However, if no viewer interaction with the pop-up window is detected within the limited time period, the process prevents the predetermined amount of rewards points associated with the advertisement and the advertiser from being provided to the viewer (step 210). In other words, the viewer does not receive the predetermined amount of rewards points associated with the advertisement and the advertiser if the viewer fails to interact with the pop-up window during the limited time period. Moreover, immediately after the limited time period, the pop-up window disappears from the screen, thereby preventing further viewer interaction with the pop-up window to claim the rewards points. In this manner, the rewards points associated with the advertisement and the advertiser can be provided to the viewer only if the viewer actually watches the advertisement, thereby incentivizing/motivating the viewer to actually watch the embedded advertisement. In some embodiments, the viewer interaction with the pop-up window includes one of: a press on the pop-up window, a touch on the pop-up window, a swipe on the pop-up window, a click on the pop-up window, and another form of interaction with the pop-up window.

Note that using the disclosed CYP pop-up program, the disclosed SMB application 104 is able to collect information of which subscribers/viewers have watched a specific Ad during a video program. In some embodiments, when the subscribed viewers are signed in to SMB application 104 with their existing social media accounts, SMB application 104 can collect and subsequently provide advertisers such information as the exact amount of views their Ads have received, and detailed information about the viewers, including, but limited to age, race, sex, and interests, thereby assisting the advertisers to develop future Ad strategies for their goods and services.

Although we have described the disclosed CYP pop-up program in terms of a pop-up window, the disclosed pop-up window can be implemented to appear on the screen in different manners, and does not have to suddenly “pop-up” on the viewer's screen. For example, in some embodiments, the disclosed pop-up window can be implemented to slide into the screen from an edge of the screen.

### Video Content Distribution Platform

Embodiments of present disclosure also provide a subscription-based video content distribution platform which is designed to provide a wide range of video contents (including both social-media-based videos and non-social-media-based videos) from a wide range of content providers (including both SMIs and non-SMI producers) to the subscribers of the video content distribution platform. Moreover, the disclosed video content distribution platform is also designed to promote a wide range of products and services associated with a wide range of participating advertisers to the subscribers through the video contents distributed on the video content distribution platform. As a result, the disclosed video content distribution platform allows the advertisers to reach a wide range of target audiences, including both users/subscribers of the video content distribution platform and followers of participating SMIs via their multiple social media accounts.

In various embodiments, the disclosed video content distribution platform also provides a unique advertising model for the advertisers to increase the incentives of the advertisers to participate in the disclosed video content distribution platform. More specifically, the disclosed advertising model is based on using “tie-in” product placement promotional advertisement and reward-based distribution of products and services in return for media-buying-free advertisements. Note that traditional cost-per-view model for an advertisement played on websites such as YouTube ranges from $0.1 to $0.3. In some embodiments and in contrast, the disclosed video content distribution platform provides a free media buying model. In other words, some embodiments of the disclosed video content distribution platform do not charge a fee for the advertisers to advertise their products and services on the video content distribution platform. Instead, an alternative Ads buying model is used where advertisers are required to allocate promoted products and services as reward distribution among the subscribers of the video content distribution platform. Hence, the disclosed video content distribution platform can redirect up to 100% of traditional Ad revenues to the users/subscribers of the video content distribution platform as an added benefit of subscription and incentive to keep making payments to the platform and watching the videos on the platform.

In some embodiments, the total value of the promotional rewards made available for users/subscribers of the video content distribution platform by the participating advertisers (i.e., the budget of Ad Campaign) can be made to be equal to or less than the budget for traditional media-buying advertising means. These media-buying advertising means include broadcast Ads such as TV and radio, online Ads such as via popular websites like YouTube, Facebook, Instagram, outdoor Ads such as billboards, printed Ads such as newspapers and magazines, among others.

As such, the disclosed video content distribution platform is designed to provide separate sets of interests and incentives to each of the parties using the video content distribution platform, i.e., (1) the content providers who produce the video contents for the video content distribution platform, such as the SMIs; (2) the subscribers/users who subscribe to the video content distribution platform to watch videos produced by the content providers and distributed on the content distribution platform; and (3) the advertisers who promote their products and services on the video content distribution platform through the videos produced by the content providers and watched by the subscribers.

In some embodiments, the video contents distributed on the disclosed video content distribution platform can include both original and non-original video contents. The original video contents can include the aforementioned social media shows, both live shows and achieved shows, produced by the SMIs and original TV shows produced by commercial content providers. Moreover, the original shows produced by the SMIs can include both multi-influencer (i.e., multi-stream) shows that are co-produced and streamed by multiple SMIs, as well as single-influencer influencer shows that is produced and streamed by a single SMI. The non-original video contents can include social media shows or TV shows produced based on adaptations of written works or existing TV shows or movies. Moreover, both of the original and non-original video contents that can be distributed on the disclosed video content distribution platform can include existing TV and movie contents, i.e., the third party contents. Furthermore, the original video contents can include both scripted original shows and unscripted original shows.

In some embodiments, the video contents distributed on the disclosed video content distribution platform can include both live video contents and pre-recorded video contents. The live video contents can include the aforementioned social media live shows produced by the one or more SMIs. The pre-recorded video contents can include the aforementioned social media shows produced by the one or more SMIs which are then uploaded onto the video content distribution platform and distributed to the subscribers at a later time on-demand.

In some embodiments, the video contents distributed on the disclosed video content distribution platform can include videos that can be watched on various viewing platforms which can include, but are not limited to: various mobile devices such as mobile phones and tablets, desktop computers, TV sets including smart TV sets, and big screens (i.e., movies).

As such, the various embodiments of the disclosed video content distribution platform described in this patent disclosure can be used to deliver advertisements from the advertisers to the subscribers of the video content distribution platform through any of the above-mentioned forms of video contents. We now describe some embodiments of the video content distribution platform in more detail.

### “Media-Buying-Free” Advertisement Scheme

In some embodiments of the disclosed video content distribution platform, advertisements for the products and services from the participating advertisers can be delivered to the subscribers through the video contents produced by the content providers. However, instead of using the traditional advertisement formats such as commercial videos which are played before, during (i.e., as commercial interruptions), or after a video streaming session, some embodiments of the disclosed video content distribution platform uses an advertisement format which does not include commercial videos. More specifically, in some embodiments, an advertisement of an advertiser is produced by integrating a particular product or a service of the participating advertiser into the narrative/storytelling of a video show/program within the video content. For example, the product or the service of the advertiser can be promoted in the video show/program by way of a product placement which is tied in with the show/program host and the show/program. As an example, the show host of a make-up show can promote a beauty product, such as a lipstick, by actually using that product in the video sequence once or multiple times. In this manner, while a subscriber watches a selected video show/program, the advertisement is presented to the subscriber as part of the show/program without a commercial interruption.

Another important feature of the disclosed video content distribution platform is that the advertisers can promote their products and services without paying an advertising charge/fee to the disclosed video content distribution platform. Instead, a participating advertiser can distribute actual products and services to the subscribers through the video content. In some embodiments, the amount of products and services distributed by the participating advertiser is equivalent to the amount of money the participating advertiser would typically spend on advertising these products and services using traditional advertising means. In some embodiments, the budget of the products and services which the advertisers need to provide for distribution as rewards can be determined based on a discounted rate.

The concept that neither the content providers, e.g., the SMIs, nor the video content distribution platform charges a fee for the product advertisement while providing the videos and platform for the subscribers to gain free products and services allows the content providers, such as the SMIs to project a “Robin Hood” like images to their fans/followers, thereby allowing them to maintain and expand their fan bases.

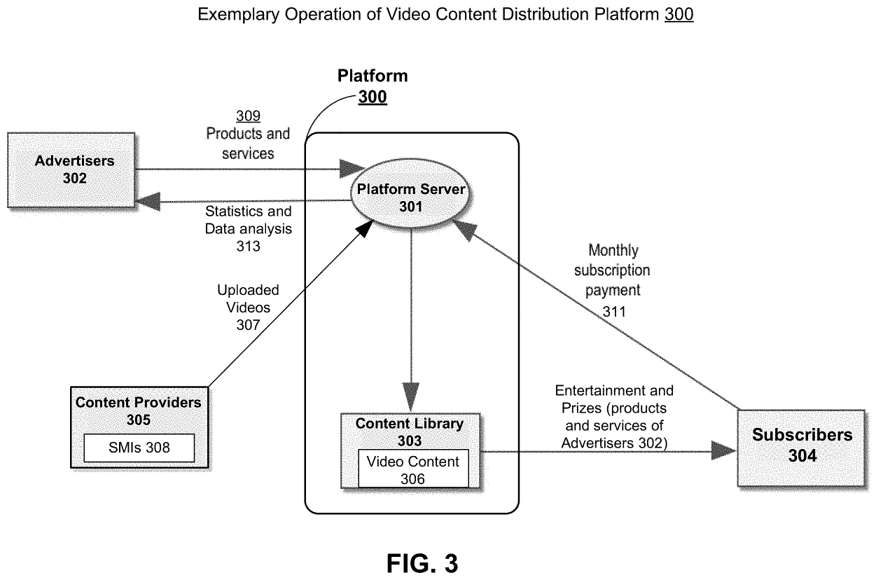

FIG. 3 shows a block diagram illustrating an exemplary operation of a disclosed video content distribution platform 300 (or “platform 300” hereinafter) through which the subscribers, the advertisers, and the content providers interact with one another in accordance with some embodiments described herein. As is further described below, platform 300 is configured to enable different disclosed functions including, but are not limited to: (1) facilitating the content providers to provide a wide range of video content to the subscribers, to increase the quality of their video content, and to increase their revenues/returns on the distributed content on platform 300; (2) facilitating the advertisers to provide product placement advertisements and reward-based distribution of products and services in return for media-buying-free advertisements and to reach a wide range of audience/subscribers without incurring conventional media buying costs; (3) facilitating the subscribers to get access to a wide range of video content from a wide range of content providers, to be compensated for their time watching the videos in the video content while enjoying their favorite video contents without being interrupted for commercial breaks, and to explore and consume video contents based on the benefits and rewards they desire to receive; and (4) facilitating motivating potential customers among the subscribers to actually want and seek opportunities to watch the advertisements from the advertisers.

As can be seen in FIG. 3, disclosed platform 300 includes at least a platform server 301 for implementing various disclosed features and performing various disclosed programs, processes, operations, and functions of platform 300. Disclosed platform 300 also includes a video content library 303 coupled to platform server 301 for storing disclosed video content 306. To reach a wider range of audience/viewers, content providers 305, such as SMIs 308 and professional filmmakers and producers, upload videos 307, which can include but not limited to, original and non-original videos, live shows and pre-recorded videos, scripted and unscripted videos onto platform 300, and more specifically to platform server 301. In some embodiments, platform server 301 is configured to convert videos 307 into video content 306 (e.g., by embedding and inserting product placement Ads) for search and consumption by the subscribers of platform 300.

To use platform 300, a plurality of advertisers 302 send their products and services 309 to platform 300, and more specifically to platform server 301. In some embodiments, the amount of products and services 309 an advertiser 302 sends to platform 300 for distribution is equivalent to the amount of money advertiser 302 would typically spend on advertising these products and services using traditional advertising means, including but not limited to broadcast Ads such as TV and radio, online Ads such as via popular websites, outdoor Ads such as billboards, printed Ads such as newspapers and magazines, among others. In some embodiments, advertisers 302 do not pay fees to platform 300 or to any of the content provides 305.

As described above, the disclosed video content distribution platform 300 can be configured to create video content 306 for a wide range of audiences/subscribers, such as subscribers 304 of platform 300. In some embodiments, platform server 301 of platform 300 creates video content 306 by integrating the products and/or services of the participating advertisers 302 into the narrative/storytelling of entertainment video shows/programs (e.g., videos 307) created for platform 300. For example, platform server 301 can create such promotional video content 306 in collaboration with host SMIs 308 (within content provider 305) hosting live shows. When creating such promotional video content 306, platform server 301 can embed and/or insert various active advertisements of advertisers 302 into videos 307. For example, the product and/or the service of an advertiser 302 can be promoted in a video show/program 307 by way of a product placement advertisement which is tied in with the show/program host and the show/program. In this manner, when subscribers 304 watch selected video content 306, the advertisements can be presented to subscribers 304 as part of the shows/programs without commercial interruptions. Consequently, the disclosed video content 306 of platform 300 is designed to offer both entertainment and prizes (i.e., the products and services of advertisers 302) to subscribers 304.

In some embodiments, subscribers 304 of platform 300 pay a subscription payment, such as a monthly payment 311, to platform 300 and more specifically to platform server 301 to gain full access to video content 306 stored in content library 303 and rewards associated with video content 306 in terms of the promoted products and services. In some other embodiments, subscribers 304 can also have a free subscription to platform 300 which is associated with a restricted access to video content 306.

In some embodiments, subscribers 304 consume video content 306 for personal entertainment by watching live video shows/programs or pre-recorded video shows/programs in video content 306. While watching a live video or a pre-recorded video in video content 306 on a screen of a user device, e.g., a mobile phone, a tablet, or a smart TV, a subscriber 304 is able to receive rewards/prizes, including products and services, by watching and responding to the advertisements embedded in the video being watched on the screen from corresponding advertisers 302. As mentioned above, advertisements of products and services of advertisers 302 can be integrated into the narrative/storytelling of the video by way of product placements which are tied in with the show/program host, which are presented to the subscriber 304 as part of the show/program without causing commercial interruption to the show/program.

In some embodiments, after a predetermined period of time (e.g., 5-10 seconds) from such a product or service placement begins to show on the screen to a subscriber 304, an interactive banner (hereinafter referred to as a “reward banner”) appears in a corner of the screen for a limited period of time (e.g., 3-5 seconds) that allows the subscriber 304 to interact with the active banner, e.g., by clicking a button labeled “Claim Your Points,” in order to claim a specific amount of reward points associated with a product or a service. In some embodiments, the reward banner also displays a countdown timer indicating the remaining time before the reward banner disappears from the screen. Moreover, the reward banner can also display a logo of the particular advertiser sponsoring the current reward. Note that instead of using a reward banner, other embodiments of platform 300 can also use an interactive window in place of the interactive banner.

Depending on the type of device a subscriber 304 is using to watch the video, different manners of interacting with the disclosed reward banner may be used. For example, if a subscriber 304 watches the video on a mobile device with a touch screen, the subscriber 304 can claim the reward points by tapping the banner on the screen. Alternatively, if a subscriber 304 watches the video on a Smart TV Set, the subscriber 304 can claim the reward points using either a TV remote or a mobile device of the subscriber 304 which can serve as a remote control when connected to the Smart TV set via interne or a local Wi-Fi network. In this embodiment, the Smart TV set and the mobile device of the subscriber 304 can be synchronized through a server using a single account of the subscriber 304. In some embodiments, after a subscriber 304 presses “Claim Your Points” on the displayed banner on the screen, a number showing how many points have been claimed for the particular prize pops up for a brief moment and disappears.

Note that a total amount of reward points required to claim a particular product or service is specified individually for each reward product or service generally based on the monetary value of the reward product or service and an advertisement budget of the advertiser providing the reward product or service. In some embodiments, when a subscriber 304 collects a sufficient amount of reward points for a reward product or service, the subscriber 304 is notified with a congratulation pop-up and a suggestion to redeem the reward.

Note that platform 300 and more specifically platform server 301 is also configured to provide advertisers 302 with accurate statistics and data analysis 313 of the effectiveness of their Ads. This is at least because platform server 301 can gain access to the social media accounts of subscribers 304. For example, platform server 301 can be configured such that in order to use platform 300, subscribers 304 have to sign in with their existing social media accounts, such as Facebook, Google, and Instagram. In some embodiments, advertisers 302 can also become involved in loyalty marketing by allowing their potential customers to try their products completely free of charge.

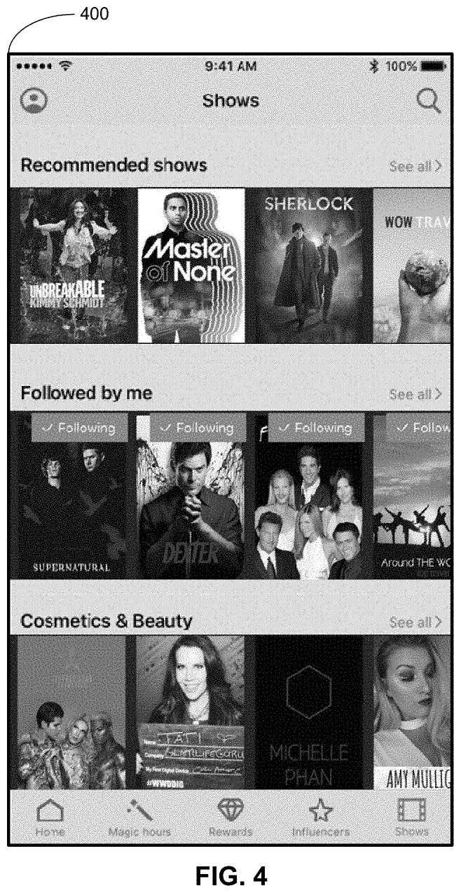

With a great number of available videos and a large number of available host SMIs and entertainers offered in video content 306, it is necessary to make searching videos and rewards efficient for subscribers 304. In some embodiments, the disclosed platform 300 and more specifically platform server 301 is configured to allow subscribers 304 to browse and consume video content 306 through a range of search options. For example, in some embodiments, the disclosed platform 300 allows subscribers 304 to search video content 306 by genres and titles of the shows in video content 306. This option is similar to Netflix, Amazon Prime Video, Hulu, and other streaming video service providers. For example, FIG. 4 shows a screen grab illustrating an exemplary user interface 400 of the disclosed video content distribution platform 300 for browsing, searching, and selecting video content 306 based on genres and titles of the shows in accordance with some embodiments described herein.

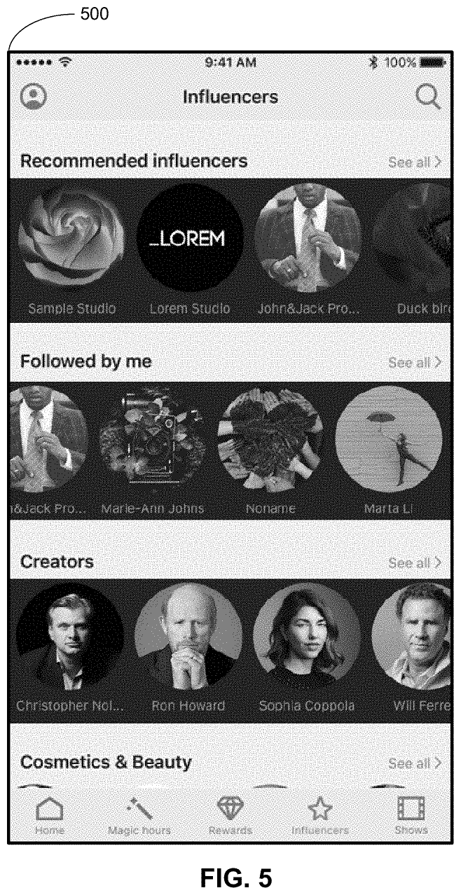

In some embodiments, the disclosed platform 300 allows subscribers 304 to search video content 306 by the host SMIs. This option is similar to YouTube, Instagram, Twitter, Facebook, among other social media platforms. For example, FIG. 5 shows a screen grab illustrating an exemplary user interface 500 of the disclosed video content distribution platform 300 for browsing, searching, and selecting video content 306 based on the host SMIs of the shows in accordance with some embodiments described herein. As can be seen in FIG. 5, the SMIs which can be searched and selected in exemplary user interface 500 can include SMIs subscribers 304 are already following, recommended SMIs, and famous film producers and actors, among others.

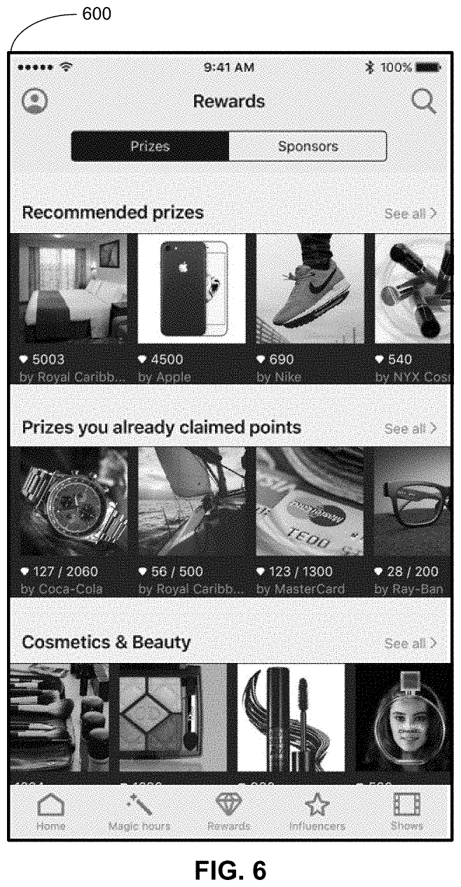

In some embodiments, the disclosed platform 300 allows subscribers 304 to search video content 306 by the available rewards and benefits. More specifically, in this option, a subscriber 304 can first explore/browse a unique in-App catalogue of available rewards and benefits from advertisers 302. As mentioned above, these rewards and benefits can be provided by advertisers 302 and distributed to subscribers 304 in exchange for media-buying-free advertisements on the disclosed platform 300. For example, FIG. 6 shows a screen grab illustrating an exemplary user interface 600 of the disclosed video content distribution platform 300 for browsing, searching, and selecting video content 306 based on the available rewards and benefits in accordance with some embodiments described herein. As can be seen in FIG. 6, the available rewards and benefits can be categorized based on the types of products and services, such as cosmetic and beauty; electronics, travel and trips, etc. In addition, the catalogue of available rewards and benefits can also include a category of products and services under “recommended prizes.” In addition, the catalogue of available rewards and benefits can also include a category of products and services which a subscriber 304 has already claimed full or partial reward points, e.g., under a category “prizes you already claimed points.”

In the example of FIG. 6, from the selection screen, i.e., user interface 600 of the disclosed in-App catalogue, a subscriber 304 can select a desired prize he/she wants to receive, which causes platform server 301 to display a list of recommended videos related to the selected prize. In other words, each video in the list of recommended shows/videos includes product or service placement advertisements and options to collect reward points toward to the desired prize. For example, a subscriber 304 can click on recommended prize by Nike™ on user interface 600 to display a list of recommended videos related to Nike™. Next, the subscriber 304 can further explore the list of recommended videos that allows him/her to receive the desired prize, e.g., a pair of Nike™ shoes. To actually receive the prize, the subscriber 304 can simply watch one or more videos in the list of recommended videos and claim reward points while watching the videos. In some embodiments, a subscriber 304 can only claim reward points associated with an embedded Ad within a recommended video during a “first time” streaming session of that recommended video. This means that subscriber 304 is not able to receive additional reward points associated with an already watched Ad by watching the same Ad one or more times, e.g., by rewinding the video back to the same Ad.

In some embodiments, platform 300 allows subscribers 304 to search video content 306 by performing an “interest search” using an in-App search engine. For example, let's say a subscriber 304 dreams about traveling to Paris. This subscriber can simply perform an In-App search such as “I want to go to Paris.” In-App search engine will then provide the subscriber with a list of relevant shows/videos that allows him/her to claim reward points for prizes sponsored by travel service providers such as airline companies, travel operators, hotel chains, restaurants, etc. To actually receive desired prizes, the subscriber can simply watch one or more videos in the list of relevant videos and claim reward points while watching the selected videos.

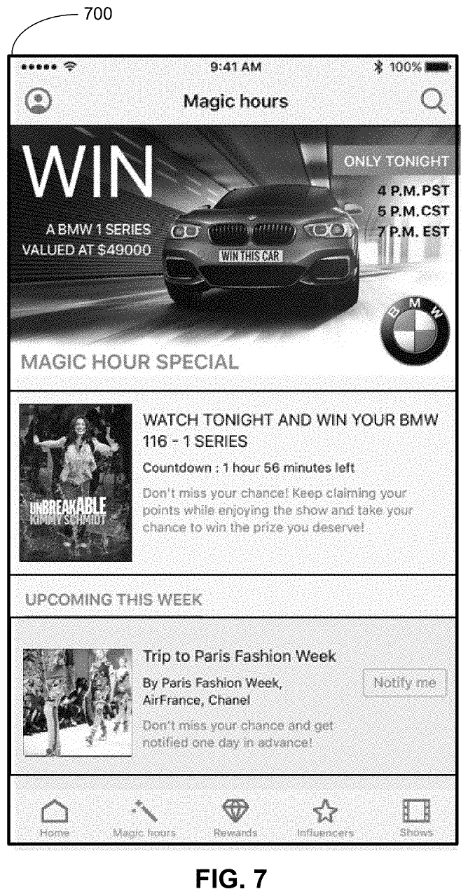

In some embodiments, the disclosed platform 300 allows subscribers 304 to search video content 306 based on a concept referred to as “magic hour”/“magic point.” More specifically, in these embodiments, very high monetary value products from luxury goods/services sponsors/advertisers can be made available on a lottery-based scheme. For example, a car manufacturer/advertiser can budget a certain amount of vehicles, e.g., with a total price equivalent to the cost of media buying cost from traditional content distributors. For example, FIG. 7 shows a screen grab illustrating an exemplary user interface 700 of the disclosed video content distribution platform 300 for displaying available “magic hour” shows and associated high monetary value prizes (e.g., a BMW SUV and a trip to Paris as shown) in accordance with some embodiments described herein.

In some embodiments, these “magic hour” shows are designed to allow a large number of subscribers 304 to simultaneously watch the shows, and a particular subscriber 304 to win an expensive prize by claiming a single magic point. However, these “magic hour” shows can be designed with much lower availability to subscribers 304 than those shows for claiming less expensive products. For example, a “magic hour” show can be made available to all subscribers 304 only during selected time slots, referred to as the “magic hours.” For example, in the example user interface 700, the BMW prize event will only happen at three indicated time slots (i.e., 4 pm, 5 pm, and 7 pm). Note that user interface 700 also shows that subscribers 304 can select one of the above described search options by simply clicking on an icon displayed at the bottom of the screen to select one of the following search options for video content 306: search by rewards; search by influencers; search by magic hours; and search by show categories. Note that additional search options not shown in the example user interface 700 can also be provided in other embodiments of the video content distribution platform 300.

In some embodiments, subscribers 304 can access and view videos in video content 306 through either iOS-based or Android-based mobile devices. In some embodiments, to ensure uninterrupted viewing experience, videos in video content 306 are produced to allow subscribers 304 to claim reward points on the screen without pausing the videos. For example, during a video viewing, a small diamond shaped icon can appear on the screen with a countdown. A viewer has to claim reward points by clicking or pressing on the icon before the countdown reaches the end, because after which the icon disappears from the screen and reward claim opportunity is lost.

As another example of an uninterrupted reward point claiming process, while a subscriber 304 is watching a selected program, product placement advertisement begins to play on the screen. After a predetermined period of time (e.g., 5-10 seconds) from such a product placement advertisement begins to show on the screen, an interactive/reward banner appears in a corner of the screen for a limited period of time (e.g., 3-5 seconds) that allows the subscriber to interact with the reward banner, e.g., by clicking a button labeled “Claim Your Points,” in order to claim the reward points associated with the advertisement. In some embodiments, the reward banner also displays a countdown timer indicating the remaining time before the reward banner disappears from the screen. Moreover, the reward banner can also display a logo of the particular advertiser sponsoring the current reward.

Note that each time a viewer/subscriber interacts with the above-described reward banner, the viewer/subscriber is able to collect reward points that can be redeemed for rewards from the advertiser who sponsors the reward banner. In some embodiments, these types of reward points are referred to as “Karats.” In some embodiments, a viewer/subscriber claims Karats by interacting with a reward banner before the countdown timer associated with the banner reaches the end, because after which the reward banner disappears from the screen and reward claim opportunity is lost. Note that viewers/subscribers can claim Karats with any of the reward points claiming techniques described in this disclosure. Next, the viewers/subscribers can redeem Karats for prizes (e.g., promotional products) from advertisers and/or targeted group of advertisers.

In some embodiments, the viewers/subscribers can claim Karats (i.e., by interacting with pop-up/reward banners) only when watching a given video content associated with the rewards banner for the first time. In these embodiments, when viewers re-watch the same video content, no pop-up/reward banner will show up again.

In some embodiments, a subscriber 304 can use a mobile device as a remote controller for his/her Smart TV set to perform aforementioned Claim-Your-Points (CYP) operation on the screen of the Smart TV set, navigate through the video content 306, leave comments and vote without interrupting the watching experience on the Smart TV set. In this embodiment, the Smart TV set and the mobile device of the subscriber 304 can be synchronized through a server using a single account of the subscriber 304.

In some embodiments, if a subscriber 304 desires to leave a comment while watching a video on a mobile device, the subscriber 304 can swipe, e.g., to the left or up depending on the specific screen orientation of the mobile device to open a comment window. After leaving the comment, the subscriber 304 can swipe in an opposite direction, e.g., right or down depending on the specific screen orientation of the mobile device to hide the window.

In some embodiments, when a subscriber 304 has claimed a sufficient amount of reward points toward a prize, a small window can slide into the screen from a side of the screen with a congratulation message and a suggestion to the subscriber 304 to redeem the prize now. For example, the small window may include a button with a message “redeem now” to allow the subscriber 304 to click on the button to redeem the prize right away. In some embodiments, the small window can also include a button with a message “continue watching and redeem later” to allow the subscriber 304 to click on the button to redeem the prize at a later time of the subscriber 304's choice. In some embodiments, after the subscriber 304 claims the prize, a small window can slide into the screen from a side of the screen with a congratulation message and a suggestion to the subscriber 304 to show the prize won on a social network with a one click on a “show prize to others” button within the small window. By doing so, the subscriber 304 can receive additional reward points toward another prize.

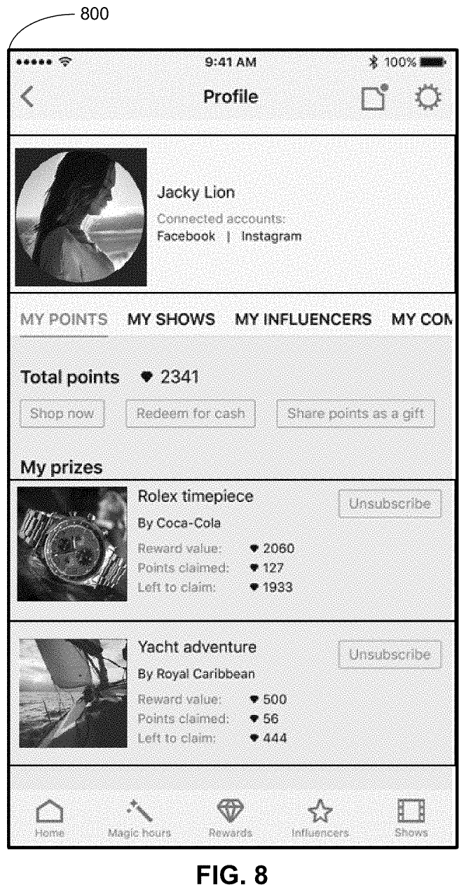

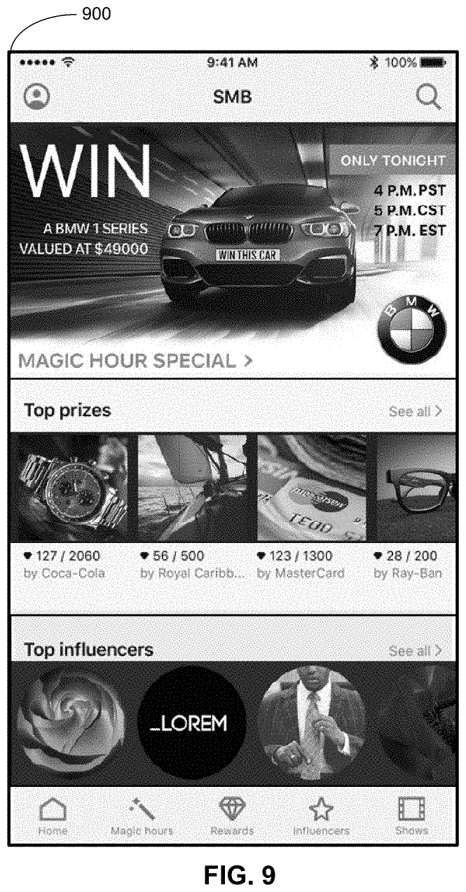

FIG. 8 shows a screen grab illustrating an exemplary user profile page 800 of a subscriber 304 to the disclosed video content distribution platform 300 in accordance with some embodiments described herein. As can be seen in FIG. 8, user profile page 800 can include a list of rewards/prizes the subscriber 304 is currently collecting with associated points information such as a total reward value, points claimed, points left to claim, etc. For example, exemplary user profile page 800 shows that the user is collecting reward points from Rolex™ toward a prize watch, and she has already claimed 127 reward points out of 2060 total reward points needed to be claimed, and hence needs to claim additional 1933 reward point to actually get the prize watch.

FIG. 9 shows a screen grab illustrating another exemplary user profile page 900 of a subscriber 304 to the disclosed video content distribution platform 300 in accordance with some embodiments described herein. As can be seen in FIG. 9, user profile 900 can include a list of rewards/prizes the subscriber 304 is currently collecting with associated points information such as a total reward value and points already claimed. Exemplary user profile page 900 also displays a list of top influencers of the subscriber 304 as well as a magic hour commercial.

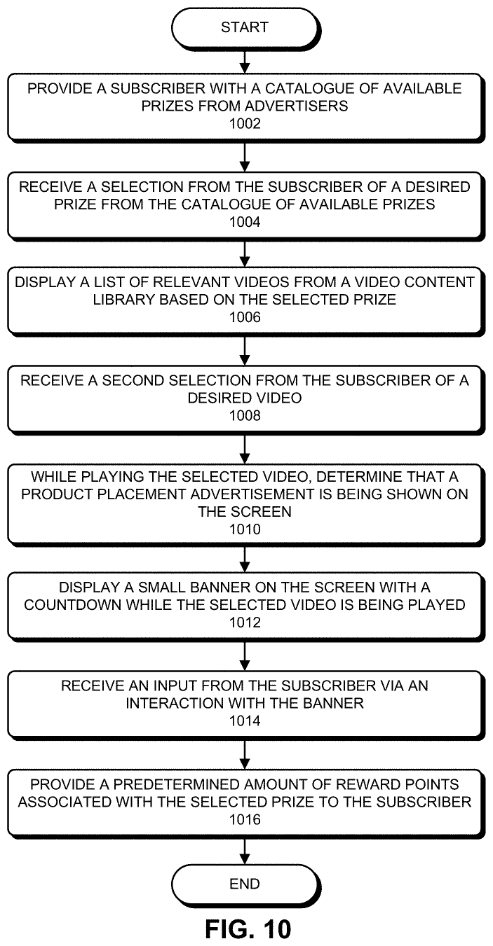

FIG. 10 presents a flowchart illustrating a process of providing reward points associated with products and services from a group of advertisers to a subscriber of the video content distribution platform 300 in accordance with some embodiments described herein. Note that the process of FIG. 10 can be performed by platform server 301. In some embodiments, the process begins by providing the subscriber with a list or a catalogue of available rewards/prizes provided by the group of advertisers on a screen of a subscriber's device (step 1002). Note that the available rewards/prizes include both available products as rewards/prizes and available services as rewards/prizes. Next, the process receives a selection from the subscriber of a desired prize from the list or the catalogue of available rewards/prizes (step 1004). Next, the process displays a list of relevant videos from a video content library on the screen of the subscriber's device based on the selected prize (step 1006). The process further receives a second selection from the subscriber of a desired video from the list of relevant videos (step 1008).

Next, the process plays the selected video on the screen of the subscriber's device, and while playing the video, the process determines that a product placement advertisement within the selected video is being shown on the screen (step 1010). The process then displays a small window/banner on the screen with a countdown while the selected video is being played (step 1012). The process subsequently receives an input from the subscriber via an interaction with the small window/banner before the countdown reaches the end (step 1014). The process then provides a predetermined amount of reward points associated with the selected prize to the subscriber (step 1016). Note that by using the interactive window/banner for claiming reward points allows the subscriber to claim/collect the reward points on the screen when the selected video is being played without pausing the video, thereby ensuring an uninterrupted viewing experience to the subscriber.

### Financial Benefits for SMIs

The above-described video content distribution platform 300 offers various financial interests and incentives for the host SMIs who serve as content providers to platform 300.

In some embodiments, video content 306 can be produced to include an ability to allow a large number of viewers to collect reward points by distributing the produced video content 306 on a non-exclusive basis to multiple social media platforms, including but not limited, the disclosed video content distribution platform 300 which can include a disclosed social-media-broadcasting platform, private social media channels of the SMIs, and many other relevant social media networks (such as Instagram and Facebook) and online video-sharing websites (such as YouTube).

In some embodiments, the followers of SMIs who are the content providers are able to automatically receive video content 306 for free in the conventional manner, e.g., by watching video content 306 on Facebook, Instagram, and YouTube. However, in some embodiments, the followers of the SMIs cannot directly claim the rewards in video content 306 but will be offered by the SMIs an option to subscribe to platform 300 and watch the shows in video content 306 on platform 300 in order to claim the rewards. In some embodiments, the SMIs do so by providing their followers with a unique active hyperlink and/or a unique promo code, so that their followers can receive a promotion such as having the first month subscription for free. Next, when a follower subscribes to platform 300 using the unique active hyperlink and/or the unique promo code, servers on platform 300 will be able to identify the particular SMI who has brought this new subscriber to platform 300, and subsequently track the activities of the new subscriber on platform 300 in relation to the particular SMI.

In some embodiments, a host SMI who hosts the live shows is entitled to a compensation of about 20% (or some other percentage numbers) of the monthly payment or royalty of about $1 (or some other dollar amounts) per month for each such new subscriber 304 the host SMI brings to platform 300, so long as this new subscriber 304 is subscribed and keeps making payment.

In some embodiments, a host celebrity who hosts the live shows instead of a host SMI is entitled to a compensation on average of up to 40% (or up to some other percentage values) of the monthly payment or royalty of about $2 (or some other dollar amounts) per month for each such new subscriber 304 the host celebrity brings to platform 300, so long as this new subscriber 304 is subscribed and keeps making payment.

In some embodiments, a guest celebrity or a guest SMI who is involved in producing and distributing one episode of the live shows is entitled to the compensation on average of up to 85% (or up to some other percentage values) of the monthly payment or royalty of about $4.25 (or some other dollar amounts) per month for each such new subscriber 304 the guest celebrity or the guest SMI brings to platform 300, so long as this new subscriber 204 is subscribed and keeps making payment.

In some embodiments, each host SMI receives a flat fee upfront compensation of up to $100,000 per year for each 1-million followers. In some embodiments, each host SMI receives 15% Ads royalties (i.e., 15% of Ad revenue generated by the live show through connected social media accounts of the particular SMI).

In some embodiments, for a given host SMI who is involved in producing and distributing one episode of the live shows, the host SMI is entitled to the compensation of:
30% royalties from Ads earnings generated by the live show from Ad exposures via connected social media accounts of the host SMI if the host SMI is in the live shot;
15% royalties from Ads earnings generated by the live show from Ad exposures via connected social media accounts of the host SMI if the host SMI is not in the live shot.

### Professional Benefits for SMIs

Most SMIs naturally strive for producing high production quality and high entertainment value video content 306 to meet the needs of their rapidly growing audience and keep their aging-out (or due to changing values) followers.

However, SMIs often are lack of expertise and experience of professional filmmakers and TV content producers, and therefore they simply cannot build a compelling story that will be able to grab the attention of the audience and hold interest through more than one single episode. As a result, SMIs often fail to hook their followers to wait for a “to be continued” episode and instead have to struggle to come up with new stories every week not related to their previous videos.

Professional filmmakers and TV content producers are highly experienced in creating arched stories and leaving “cliff-hangers” at the end of an episode to keep the audience anxiously waiting for an entire week to satisfy their curiosity. In some embodiments, such professional filmmakers and TV content producers can be recruited to assist SMIs to produce episodes of shows with a continuous flow of content and help them to achieve higher production and entertainment value of the future content.

Note that users who consume video content 306 through their mobile devices often have a shorter attention span and further due to the relative small sizes of the screens, prefer shorter videos compared to those users (which can be exactly the same users) who consume video content 306 through big screen TV sets. In some embodiments, to meet expectations and satisfy viewing experiences of both types of users, video content 306 produced within original formats can be produced in 12-45 minutes long episodes, after which each episode can be fragmented into 3-5 minute short segments. This segmentation technique will allow SMIs to broadcast the content on a more frequent basis (e.g., several times per week) to aid and improve consumption of the content through mobile devices, thereby allowing the users to navigate each episode (e.g., at the end of the week) with ease. Note that creating such segmented contents puts higher requirements and expectations on creative writing and production.

The produced video content 306 can then be distributed on a non-exclusive basis to multiple social media platforms, including but not limited, the disclosed video content distribution platform 300 which can include a disclosed social-media-broadcasting platform, private social media channels of the SMIs, and many other relevant social media networks (such as Instagram and Facebook) and online video-sharing websites and Online Video-Sharing Websites (such as YouTube).

### Benefits for Producers and Writers

One of the important benefits that the SMIs receive when working as a content provider for the disclosed video content distribution platform 300 is the option to collaborate with professional filmmakers, producers and writers who can assist the SMIs (e.g., with techniques used in traditional TV production) to substantially increase the production quality of the SMI-produced video content. One reason for which professional filmmakers, producers and writers will be highly interested in working with SMIs to create the content is that these professional filmmakers, producers and writers are also interested in receiving a very high (e.g., according to Hollywood standards) monthly royalty from the subscription money of each of the followers that an SMI brings to video content distribution platform 300.

### Summary of Benefits for Multiple Parties of the Disclosed Platform

As mentioned above, the disclosed video content distribution platform 300 provides separate sets of interests, benefits, and incentives to each of the parties using the disclosed video content distribution platform: i.e., the content providers who produce video contents for the disclosed video content distribution platform, such as the SMIs; the subscribers who subscribe to the disclosed video content distribution platform to watch videos produced by the content providers and distributed through the disclosed content distribution platform; and the advertisers who promote their products and services on the disclosed video content distribution platform through the videos produced by the content providers and watched by the subscribers.

For the subscribers of the disclosed video content distribution platform, the set of benefits they can receive through this platform can include, but are not limited to one or more of the following:
being compensated for their time watching the videos in the video content while enjoying their favorite video contents;
watching the video programs without being interrupted for commercial breaks;
receiving an enhanced “lottery-like” entertainment experience while watching some of the video contents;
exploring and consuming video contents based on the benefits and rewards they desire to receive; and
experiencing immersive escapism through interactive 360° video content in the company of their friends.

For the advertisers of the disclosed video content distribution platform, the set of benefits they can receive through this platform can include, but are not limited to one or more of the following:
reaching a wide range of audience/subscribers without incurring conventional media buying costs (i.e., via “media-buying-free” advertisements described in this patent disclosure);
reducing marketing expenses, and as a result, potentially lowering retail prices for the advertised products and/or services on the disclosed video content distribution platform;
motivating potential customers among the subscribers to actually want and seek opportunities to watch their advertisements. Note that this is one of the highly unique features for attracting potential customers provided by the disclosed video content distribution platform;
monitoring and analyzing detailed data associated with each and every active video content consumption action (e.g., in one embodiment, to claim a reward or a benefit associated with an advertiser, subscribers need to interact with an advertisement by clicking a button);
benefiting from an ancillary viral effect (e.g., a “word of mouth” effect) through each subscriber who gets to claim and receive desired product and/or service from the advertiser on the disclosed video content distribution platform; and
building strong loyalty relationships with prospective customers.

In some embodiments, advertisers receive the most transparent and most detailed Ad campaign report for each channel of distribution of the live show in real-time. Sales price from retail sales with special promo coupons of the product and service can be advertised in the live show.

For the content providers of the disclosed video content distribution platform, such as the SMIs, the set of benefits they can receive through this platform can include, but are not limited to one or more of the following:
avoiding financial losses resulted from unreasonably high content distribution fees;
significantly increasing their revenues;
increasing the quality of their video content; and
positioning themselves to their fans/followers as “Robin Hoods” (as described above).

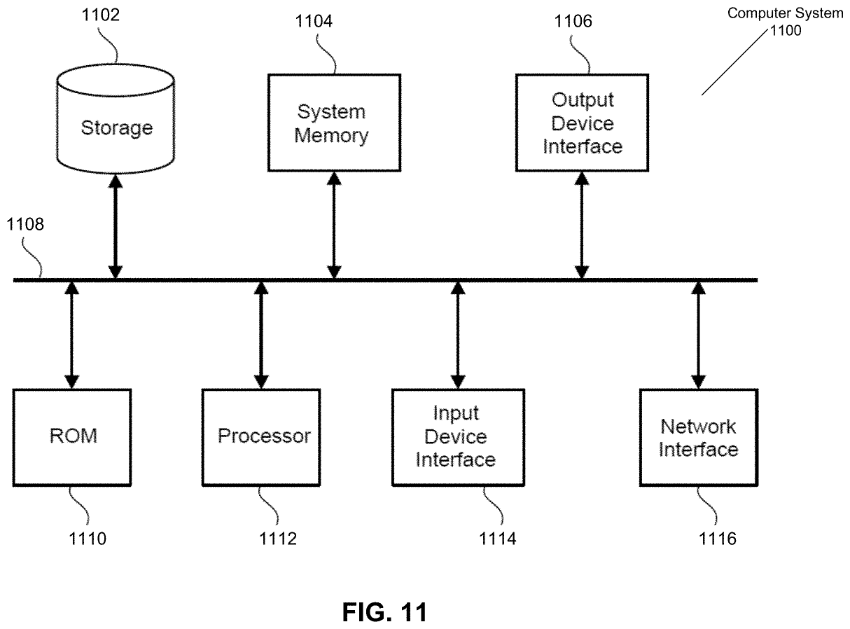

FIG. 11 conceptually illustrates a computer system 1100 with which some embodiments of the subject technology are implemented. Computer system 1100 can be a client, a server, a computer, a smartphone, a PDA, a laptop, or a tablet computer with one or more processors embedded therein or coupled thereto, or any other sort of electronic device. Such a computer system includes various types of computer readable media and interfaces for various other types of computer readable media. Computer system 1100 includes a bus 1108, processing unit(s) 1112, a system memory 1104, a read-only memory (ROM) 1110, a permanent storage device 1102, an input device interface 1114, an output device interface 1106, and a network interface 1116.

Bus 1108 collectively represents all system, peripheral, and chipset buses that communicatively connect the numerous internal devices of computer system 1100. For instance, bus 1108 communicatively connects processing unit(s) 1112 with ROM 1110, system memory 1104, and permanent storage device 1102.

From these various memory units, processing unit(s) 1112 retrieves instructions to execute and data to process in order to execute the disclosed systems, processes, and techniques of the subject disclosure, including the above-described systems, processes, and techniques of providing/viewing video content and advertisements, and providing/receiving reward points and reward products and services through the disclosed SMB application 104 described in conjunction with FIGS. 1 and 2; and the systems, processes, and techniques of providing/viewing video content and media-buying-free advertisements, and providing/receiving reward points/rewards/prizes and reward-based distribution of products and services through the disclosed video content distribution platform 300 described in conjunction with FIGS. 3-10. The processing unit(s) can be a single processor or a multi-core processor in different implementations.

ROM 1110 stores static data and instructions that are needed by processing unit(s) 1112 and other modules of the computer system. Permanent storage device 1102, on the other hand, is a read-and-write memory device. This device is a non-volatile memory unit that stores instructions and data even when computer system 1100 is off. Some implementations of the subject disclosure use a mass-storage device (such as a magnetic or optical disk and its corresponding disk drive) as permanent storage device 1102.

Other implementations use a removable storage device (such as a floppy disk, flash drive, and its corresponding disk drive) as permanent storage device 1102. Like permanent storage device 1102, system memory 1104 is a read-and-write memory device. However, unlike storage device 1102, system memory 1104 is a volatile read-and-write memory, such a random access memory. System memory 1104 stores some of the instructions and data that the processor needs at runtime. In some implementations, the disclosed systems, processes, and techniques of the subject disclosure, including the systems, processes, and techniques of providing/viewing video content and advertisements, and providing/receiving reward points and reward products and services through the disclosed SMB application 104 described in conjunction with FIGS. 1 and 2; and the systems, processes, and techniques of providing/viewing video content and media-buying-free advertisements, and providing/receiving reward points/rewards/prizes and reward-based distribution of products and services through the disclosed video content distribution platform 300 described in conjunction with FIGS. 3-10, are stored in system memory 1104, permanent storage device 1102, and/or ROM 1110. From these various memory units, processing unit(s) 1112 retrieves instructions to execute and data to process in order to execute the processes of some implementations.

Bus 1108 also connects to input and output device interfaces 1114 and 1106. Input device interface 1114 enables the user to communicate information and select commands to computer system 1100. Input devices used with input device interface 1114 include, for example, alphanumeric keyboards and pointing devices (also called “cursor control devices”). Output device interfaces 1106 enables, for example, the display of images generated by computer system 1100. Output devices used with output device interface 1106 include, for example, printers and display devices, such as cathode ray tubes (CRT) or liquid crystal displays (LCD). Some implementations include devices such as a touchscreen that functions as both input and output devices.

Finally, as shown in FIG. 11, bus 1108 also couples computer system 1100 to a network (not shown) through a network interface 1116. In this manner, the computer can be a part of a network of computers (such as a local area network (“LAN”), a wide area network (“WAN”), or an Intranet, or a network of networks, such as the Internet. Any or all components of computer system 1100 can be used in conjunction with the subject disclosure.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this patent document.

1. A computer-implemented method of providing reward points associated with products and services of a group of advertisers to a subscriber of a video content distribution platform, the method comprising:
displaying a list of available rewards offered by the group of advertisers on a screen of a subscriber's device;
receiving a first selection from the subscriber of a desired reward from the list of available rewards;
displaying, on the screen of the subscriber's device, a list of relevant videos from a content library of the video content distribution platform based on the first selection, wherein the relevant videos include embedded advertisements associated with the desired reward;
receiving a second selection from the subscriber of a desired video from the list of relevant videos; and
playing, on the screen of the subscriber's device, the selected video based on the second selection, whereby allowing the subscriber to claim reward points associated with the desired reward while watching the selected video.

2. The computer-implemented method of claim 1, wherein the method further comprises creating the list of relevant videos by:
creating a set of entertainment videos in collaboration with a group of social media influencers (SMIs);
embedding advertisements of products and/or services of the group of advertisers into the set of entertainment videos; and
associating the embedded advertisements in the set of entertainment videos with the list of available rewards to create the list of relevant videos.

3. The computer-implemented method of claim 2, wherein embedding the advertisements of the products and/or services of the group of advertisers into the set of entertainment videos includes integrating the products and/or services with the narratives of the set of entertainment videos.

4. The computer-implemented method of claim 3, wherein integrating the products and/or services with the narratives of the set of entertainment videos includes creating products and/or services placement advertisements in the set of entertainment videos to tied in the products and/or services with the storytelling within the set of entertainment videos.

5. The computer-implemented method of claim 1, wherein the method further comprises:
while playing the selected video, determining that an embedded advertisement within the selected video is being shown on the screen;
displaying a small window on the screen while the selected video is being played;
receiving an input from the subscriber caused by the subscriber interacting with the small window; and
providing a predetermined amount of reward points associated with the desired reward of the subscriber to the subscriber, wherein allowing the subscriber to collect the reward points when the selected video is being played without pausing the video ensures an uninterrupted viewing experience to the subscriber.

6. The computer-implemented method of claim 5, wherein the small window disappears from the screen after a limited time period, and wherein the subscriber is only able to collect the reward points if the subscriber interacts with the small window before the small window disappears.

7. The computer implemented method of claim 5, wherein the small window includes a countdown timer, and wherein the subscriber claims the reward points by interacting with the small window before the countdown timer reaches zero.

8. The computer-implemented method of claim 1, wherein the method further comprises:
determining that the subscriber has claimed a sufficient amount of reward points toward the desire reward; and
displaying on a side of the screen options to allow the subscriber to redeem the desire reward right now or at a later time.

9. The computer-implemented method of claim 1, wherein the method further comprises only allowing the subscriber to claim the reward points associated with the desired reward during a first streaming session of the selected video.

10. The computer-implemented method of claim 1, wherein the group of advertisers allocates an amount of products and/or services as reward distribution among a group of subscribers of the video content distribution platform in return for receiving media-buying-free advertisements of the products and services on the video content distribution platform.

11. A computer-implemented method of administrating reward points associated with a product or a service to a viewer watching a video program containing advertisements on a screen, the method comprising:
determining that an advertisement associated with an advertiser is being shown to the viewer watching the video program;
while the advertisement is being shown or immediately after the advertisement has been shown, displaying a pop-up window at an off-center location of the screen;
awaiting the viewer to interact with the pop-up window within a limited time period; and
if a viewer interaction with the pop-up window is detected within the limited time period, providing a predetermined amount of reward points associated with the advertisement and the advertiser to the viewer;
if no viewer interaction with the pop-up window is detected within the limited time period, preventing the predetermined amount of reward points associated with the advertisement and the advertiser from being provided to the viewer,
wherein the pop-up window disappears from the screen immediately after the limited time period, thereby preventing further viewer interaction with the pop-up window.

12. The computer-implemented method of claim 11, wherein the video program includes one of a social media live show being broadcasted or an archived social media show being played-back from a video content library.

13. The computer-implemented method of claim 11, wherein the advertisement includes one of: a product placement advertisement, a running banner advertisement, and a standard linear video advertisement.

14. The computer-implemented method of claim 11, wherein the pop-up window has a size significantly smaller than the size of the screen so that the pop-up window does not block the screen.

15. The computer-implemented method of claim 11, wherein the pop-up window does not interrupt either the video program or the advertisement being playing on the screen.

16. The computer-implemented method of claim 11, wherein the viewer interaction with the pop-up window includes one of: a press on the pop-up window, a touch on the pop-up window, a swipe on the pop-up window, a click on the pop-up window, and another form of interaction with the pop-up window.

17. The computer-implemented method of claim 11, wherein the viewer does not receive the predetermined amount of reward points associated with the advertisement and the advertiser if the viewer fails to interact with the pop-up window during the limited time period.

18. The computer-implemented method of claim 11, wherein the reward points associated with the advertisement and the advertiser are provided to the viewer only if the viewer has actually watched the advertisement, thereby motivating the viewer to watch the advertisement.

19. The computer-implemented method of claim 11, wherein the limited time period is relatively short so that the viewer needs to take prompt action after the pop-up window appears on the screen.

20. The computer-implemented method of claim 11, wherein the pop-up window includes a countdown timer indicating the remaining time before the pop-up window disappears from the screen.

21. A system for providing reward points associated with products and services of a group of advertisers to a subscriber, the system comprising:
one or more processors; and
memory storing instructions that, when executed by the one or more processors, cause the system to:
display a list of available rewards offered by the group of advertisers on a screen of a subscriber's device;
receive a first selection from the subscriber of a desired reward from the list of available rewards;
display, on the screen of the subscriber's device, a list of relevant videos from a content library based on the first selection, wherein the relevant videos include embedded advertisements associated with the desired reward;
receive a second selection from the subscriber of a desired video from the list of relevant videos; and
play, on the screen of the subscriber's device, the selected video based on the second selection, whereby allowing the subscriber to claim reward points associated with the desired reward while watching the selected video.

22-33. (canceled)
